(19) United States
(12) Patent Application Publication
(10) Pub. No.: US 2012/0233270 A1
(43) Pub. Date: Sep. 13, 2012

(54) METHOD FOR TRANSMITTING AND RECEIVING MESSAGES

(75) Inventors: Hong-Lin LEE, Taipei (TW); Wen-Hsiung Tsai, Taipei (TW); Ya-Ting Hsu, Taipei (TW)

(73) Assignee: LINKTEL INC., Taipei (TW)

(21) Appl. No.: 13/403,028

(22) Filed: Feb. 23, 2012

(30) Foreign Application Priority Data
Mar. 7, 2011 (TW) 100107616

(51) Int. Cl. G06F 15/16

(52) U.S. Cl. 709/206

(57) ABSTRACT

A method for transmitting and receiving messages is used for a server. The method comprises: receiving sender information including a sender identification information, a sender message, and a receiver E-mail address; providing a sender E-mail address; sending a first E-mail including the sender message from the sender E-mail address to the receiver E-mail address; receiving a second E-mail including a reply message sent from the receiver address to the sender address; and transmitting the reply message to the sender.

### BACKGROUND OF THE INVENTION

1. Field of the Invention

The present invention relates to a method for transmitting and receiving messages; more particularly, the present invention relates to a method for transmitting and receiving messages capable of allowing a server to provide a sender e-mail address and to send an e-mail automatically; and receiving the e-mail as well as displaying a message in a chat box.

2. Description of the Related Art

In modern digital life, users can utilize many electronic devices, such as mobile phones, personal digital assistants (PDA), laptop computers, and tablet computers, to send or receive messages via software. However, so far, such kinds of services have a limitation, that both the sender and the receiver need to have installed the same software. For example, the sender cannot utilize Microsoft Messenger (MSN) to send a message to a receiver who has not installed MSN. As a result, the sender needs to utilize other methods, such as sending a short message, placing a phone call, or sending an e-mail, to transmit the message to the receiver. These methods entail other disadvantages, including extra cost and time of sending a short message or placing a phone call, or the inconvenience of re-writing the message to be sent as an e-mail. These disadvantages are very inconvenient for users.

Therefore, there is a need to provide a method for transmitting and receiving messages to mitigate and/or obviate the aforementioned problems. With the use of communication software, a sender can input a sender message and select an e-mail receiver; a server can provide a sender e-mail address and automatically send an e-mail from the sender e-mail address to the e-mail receiver; then the server can receive an e-mail reply by the e-mail receiver and send the reply message to the original sender for being displayed in a chat box of the communication software.

### SUMMARY OF THE INVENTION

It is an object of the present invention to provide a method for transmitting and receiving messages, which is implemented in a server, such that the user can transmit messages between a sender and a receiver via a network.

It is another object of the present invention to provide a method for transmitting and receiving messages, which is used in an electronic device, wherein a sender can communicate with a receiver via a network.

To achieve the abovementioned objects, the method for transmitting and receiving messages of the present invention is implemented in a server, wherein the method comprises the following steps:

A. receiving sender information transmitted from a sender, wherein the sender information includes sender identification information, a sender message, and a receiver e-mail address;

B. providing a sender e-mail address;

C. sending a first e-mail from the sender e-mail address to the receiver e-mail address, wherein the first e-mail includes the sender message;

D. receiving a second e-mail reply from the receiver e-mail address to the sender e-mail address, wherein the second e-mail includes a reply message; and

E. transmitting the reply message to the sender.

The method for transmitting and receiving messages used in the server provides the sender e-mail address by the server, such that the server, in place of the sender, can send the sender message to the receiver in the form of an e-mail. Then the server can receive the e-mail reply by the receiver and transmit the reply message included in the e-mail to the sender for being displayed in the chat box. As a result, the sender and the receiver can communicate with each other without having installed the same software, and the inconvenience of re-writing the e-mail can be avoided as well.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a schematic drawing showing a usage environment of an e-mail server according to one embodiment of the present invention.

FIG. 2 shows functions of primary program codes of a message transmission program according to one embodiment of the present invention.

FIG. 3 illustrates a flowchart of the method according to one embodiment of the present invention.

FIG. 4 illustrates a schedule drawing showing a message input screen according to one embodiment of the present invention.

FIG. 5 illustrates a schematic drawing showing a receiver list according to one embodiment of the present invention.

FIG. 6 illustrates a schematic drawing of a database according to one embodiment of the present invention.

FIG. 7 illustrates a schematic drawing of a first e-mail according to one embodiment of the present invention.

FIG. 8 illustrates a schematic drawing of a second e-mail according to one embodiment of the present invention.

FIG. 9 illustrates a schematic drawing of a chat box according to one embodiment the present invention.

### DETAILED DESCRIPTION OF THE PREFERRED EMBODIMENT

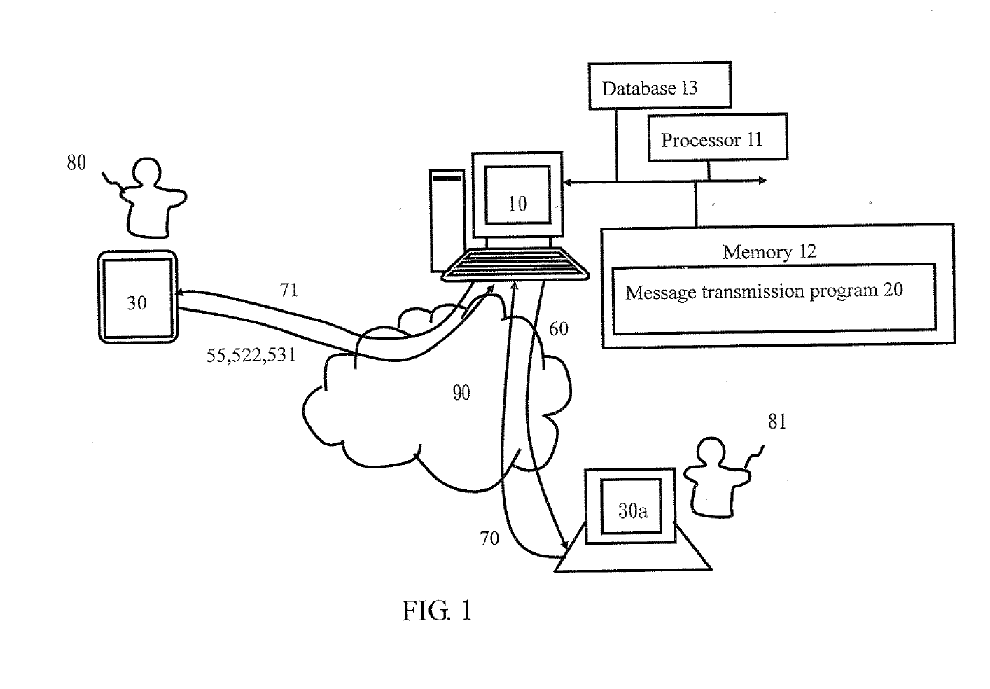

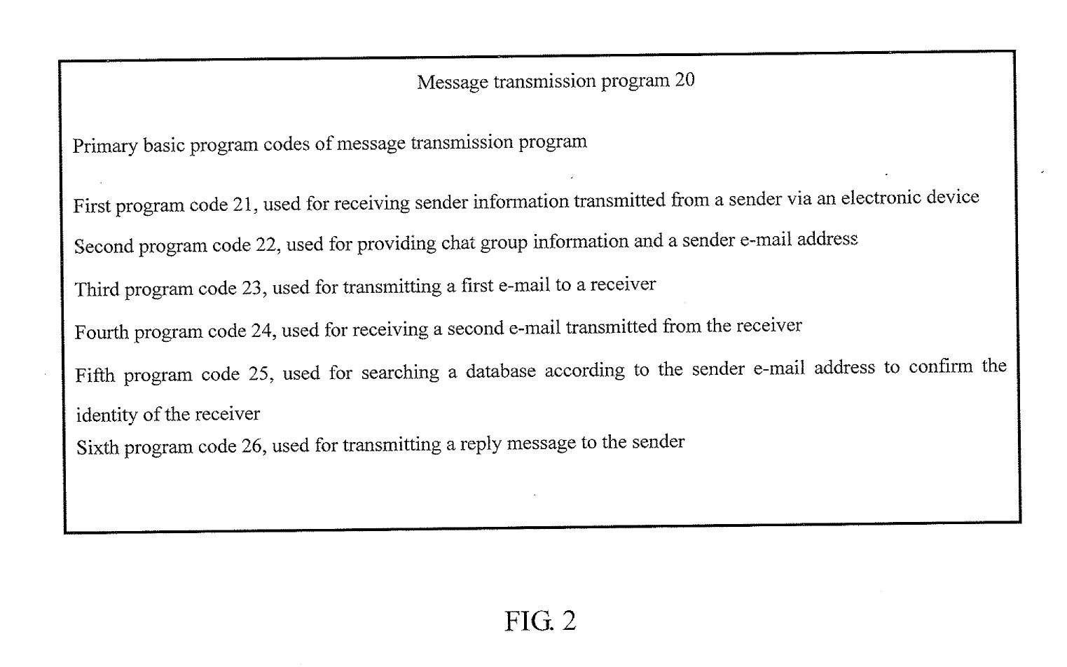

Please refer to FIG. 1 and FIG. 2, which respectively illustrate a schematic drawing showing a usage environment of an e-mail server, and functions of primary program codes of a message transmission program according to the present invention. A sender 80 uses an electronic device 30 to connect to a server 10 via a network 90, so as to send a message to a receiver 81, wherein the receiver 81 can utilize an electronic device 30a to receive the message. In order to achieve this object, the sender 80 would transmit sender information, which comprises sender identification information 55, a sender message 531, and a receiver e-mail address 522. After the server 10 receives the sender information, it provides a sender e-mail address 61 and uses the sender e-mail address 61 to send a first e-mail 60 to the receiver e-mail address 522. Then the receiver 81 replies with a second e-mail 70 to the server 10, wherein the second e-mail 70 includes a reply message 71. The server 10 then returns the reply message 71 to the sender 80. Furthermore, the server 10 comprises a processor 11, a memory 12, and a database 13, wherein the memory 12 contains a message transmission program 20. The method for transmitting and receiving messages of the present invention executes the message transmission program 20 through the processor 11 so as to generate the steps of the present invention. Please refer to FIG. 2 for each primary program code of the message transmission program 20 related to the present invention. The functions of the primary program codes will be described in detail while the steps of the present invention are introduced. In this embodiment, the electronic device 30 used by the sender 80 is a tablet computer, and the electronic device 30a used by the receiver 81 is a desktop computer. Please note that electronic device applicable for the present invention is not limited to the above description; the electronic devices 30 and 30a can be desktop computers, laptop computers, mobile phones, personal digital assistants (PDA), tablet computers, or other electronic devices capable of executing the message transmission program 20. Please also note that although there is only one receiver 81 in this embodiment, the actual number of receivers is not limited to the above scope. Practically, the method for transmitting and receiving messages of the present invention can send a sender message to a plurality of receivers.

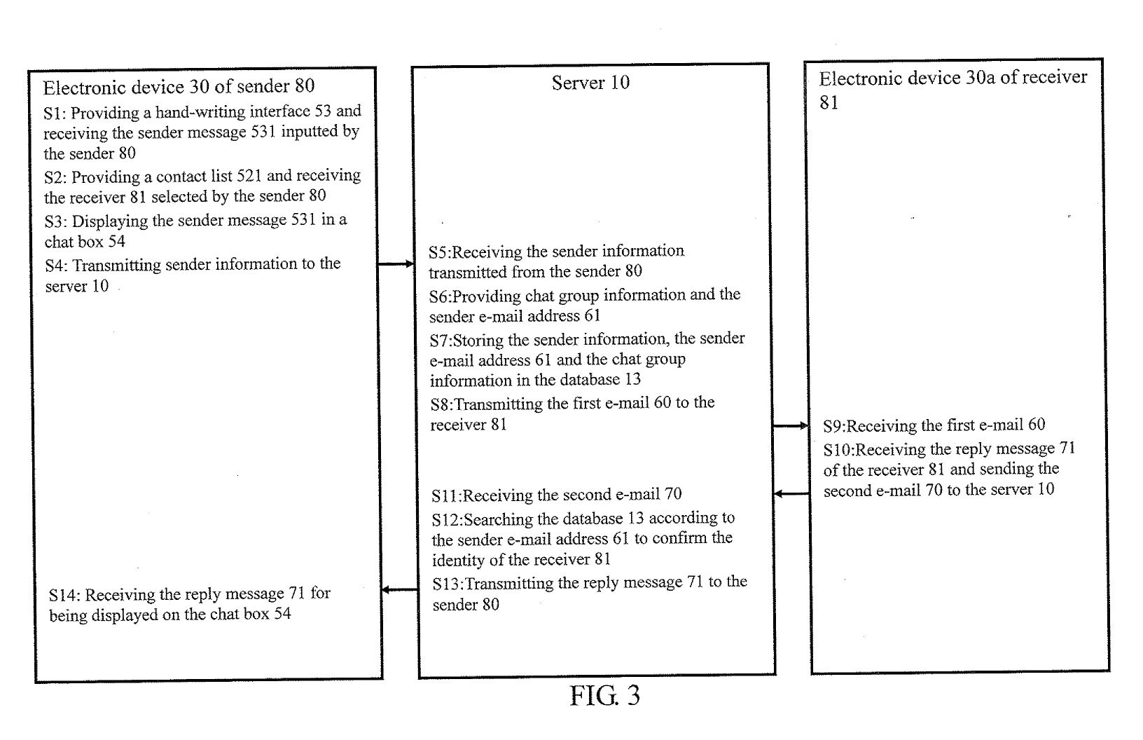

Please refer to FIG. 3, which illustrates a flowchart of the method according to the present invention. Please also refer to FIG. 2 and FIGS. 4-9, which relate to the first embodiment of the present invention.

### Step S1: Providing a Hand-Writing Interface 53 and Receiving the Sender Message 531 Inputted by the Sender 80.

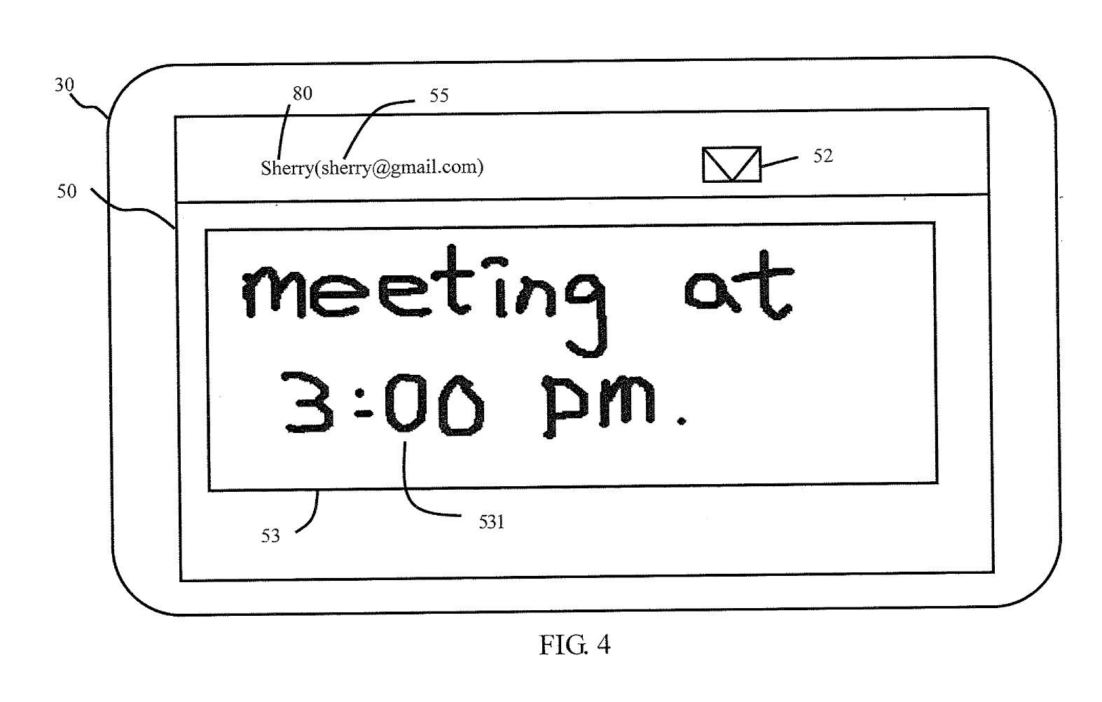

Please refer to FIG. 4, which illustrates a monitor display screen of the electronic device 30 of the sender 80. In a function window 50, its upper area displays sender identification information 55 and a contact icon 52, and its lower area displays a hand-writing interface 53 for the sender 80 to input the sender message 531. For example, the sender 80 writes down “meeting at 3:00 pm” as an input. Please note that in this embodiment, the sender identification information 55 is, but is not limited to, an e-mail address of the sender 80. Practically, the sender identification information 55 can be a nickname, an account, or any other identification information of the sender 80 that is capable of representing the sender 80.

Furthermore, in this embodiment, the sender 80 uses, but not is limited to, a stylus or a finger to input the sender message 531 on the hand-writing interface 53. The sender 80 can use other auxiliary external components to perform the hand-writing input step. Furthermore, the writing method applicable for the present invention is not limited to hand-written input. A keyboard or other input device can also be utilized to directly input a word or image so as to increase the applicability of the present invention.

### Step S2: Providing a Contact List 521 and Receiving the Receiver 81 Selected by the Sender 80.

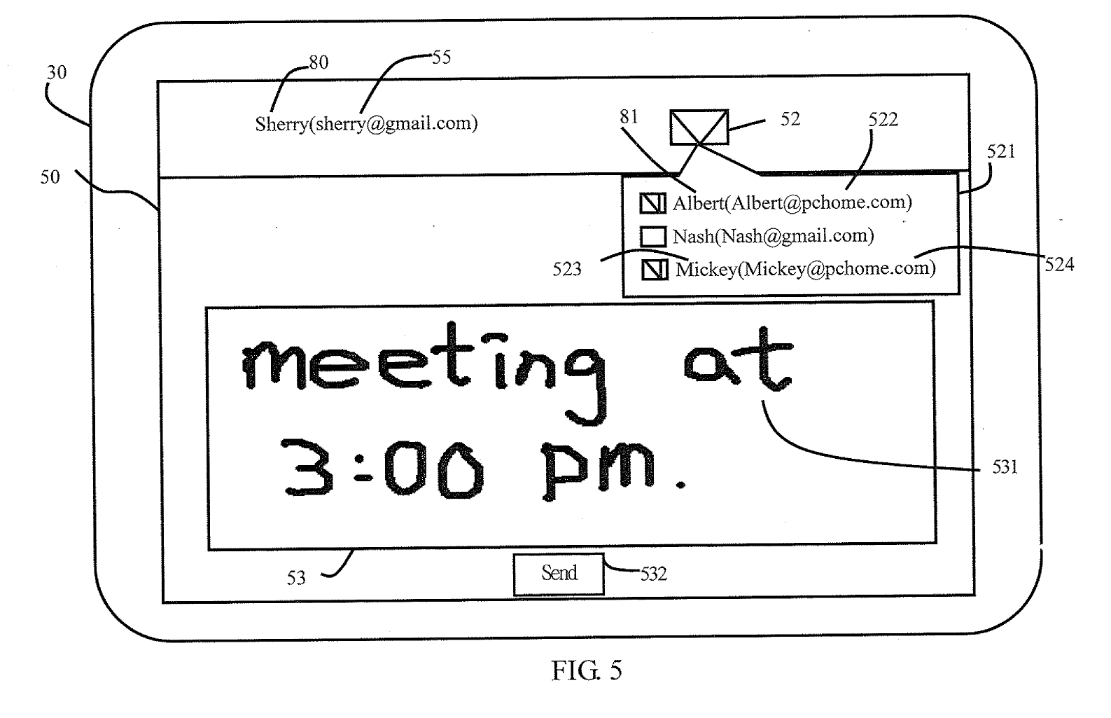

Please refer to FIG. 5; the sender 80 clicks the contact icon 52 to display the contact list 521 so as to select a contact person therefrom for transmitting a message. Please note that contact persons for transmitting messages can be divided into two groups: One group refers to a contact person who utilizes the same application software as the sender 80 does, and can become a friend for directly transmitting the message after the sender 80 clicks; the other group refers to a contact person who does not utilize the same application software, and becomes a receiver after the sender 80 clicks, wherein the e-mail address of the contact person can be used as the receiver e-mail address. In this embodiment, the sender 80 clicks Mickey to be a friend 523, wherein Mickey's e-mail address, Mickey@pchome.com, is used as the friend identification information 524.

The sender 80 further clicks Albert to be the receiver 81, wherein Albert@pchome.com is used as the receiver e-mail address 522. Moreover, in this embodiment, although there is only one receiver and one friend, the actual numbers of the receivers and friends are not limited to the above scope. Practically, the method for transmitting and receiving messages of the present invention can send a sender message to a plurality of contact persons.

Please note that the friend 523, who utilizes the same application software as the sender 80 does, can directly receive the sender message 531 from the sender 80, which is a known transmission technique and is not the key point of the present invention; therefore, there is no need for further description. For example, both sides can directly communicate with each other via the same application software, such as MSN-to-MSN or Skype-to-Skype. Please refer to Taiwan Patent No. 1330971 for more information about the hand-written message input and transmission described above. However, if the sender 80 would like to send the sender message 531 to other friends who cannot directly receive it, the present invention provides a method for transmitting and receiving messages via e-mails that can be applied to solve the above problem.

### Step S3: Display the Sender Message 531 in a Chat Box 54.

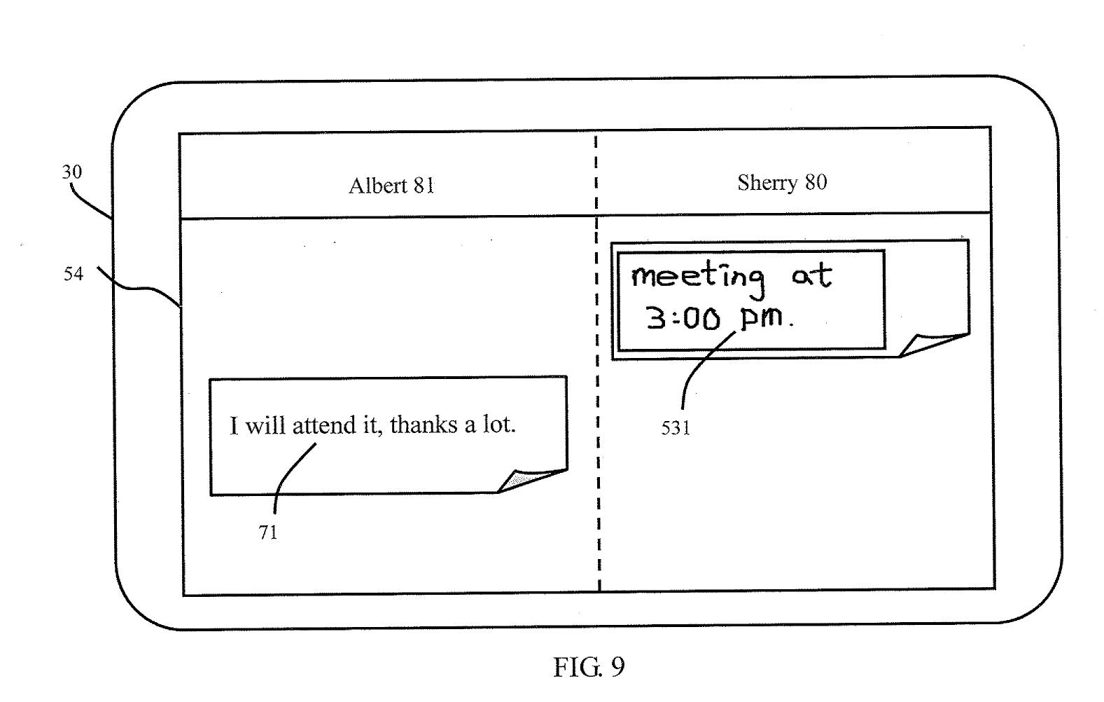

Please refer to FIG. 9; the electronic device 30 provides a chat box 54 for displaying the sender message 531 in a field for the sender 80. The method of displaying the sender message 531 is not limited to the form of the image shown in FIG. 9. The sender message 531 can be parsed right after being transmitted, and can be directly displayed in the form of text or other possible modes in the chat box 54.

### Step S4: Transmitting Sender Information to the Server 10.

As shown in FIG. 5, after the sender 80 inputs the sender message 531 and selects the friend 523 and the receiver 81, the sender 80 can then click a “Send” button 532 to transmit the sender information to the server 10. The sender information includes, but is not limited to, the sender message 531, the sender identification information 55, and the receiver e-mail address 522. In this embodiment, the sender information further includes the friend identification information 524.

Step S5: the Server 10 Receiving the Sender Information Transmitted from the Sender 80.

After the server 10 receives the sender information, it can directly transmit the sender message 531 to the friend 523. However, with regard to the receiver 81, the sender message 531 has to be transmitted according to the steps described hereinafter. In this embodiment, step S5 is executed by the first program code 21 of the message transmission program 20.

### Step S6: Providing Chat Group Information and the Sender E-Mail Address 61.

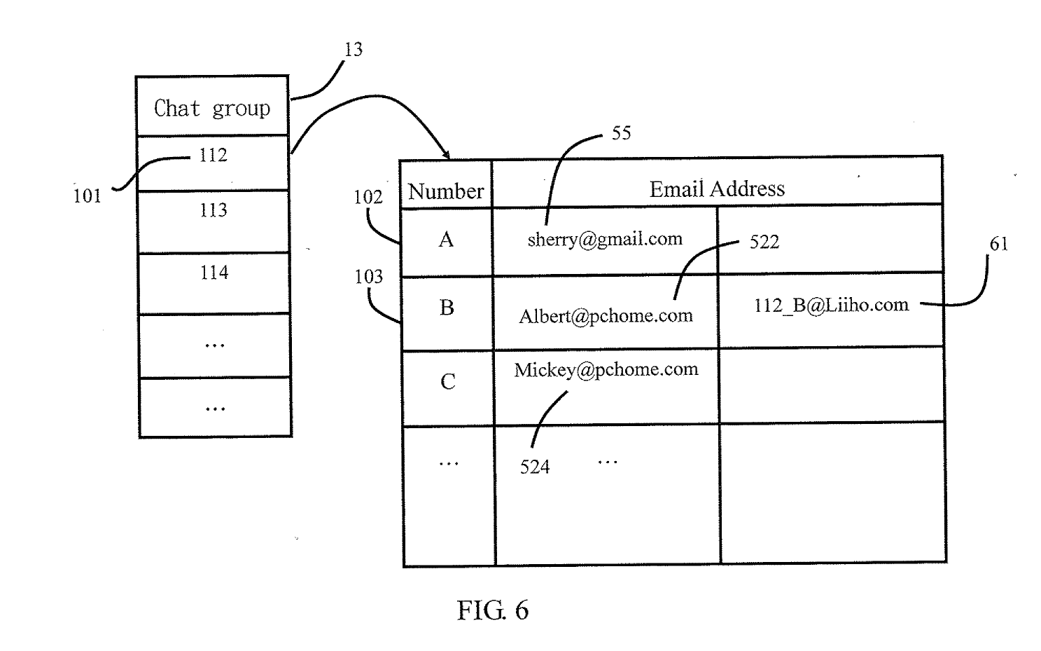

Please refer to FIG. 6. After the server 10 receives the sender information, it immediately edits the sender identification information 55, the receiver e-mail address 522, and the friend identification information 524 into the same chat group so as to generate a chat group number 101, a sender number for the chat group 102, and a receiver number for the chat group 103, and to generate the sender e-mail address 61 according to the chat group number 101 and the receiver number for the chat group 103. In this embodiment, the server 10 generates a chat group, which includes three contact persons, Sherry, Albert, and Mickey, and the server 10 respectively edits the chat group number 101 as 112, the sender number for the chat group 102 as A, and the receiver number for the chat group 103 as B. Then, according to the chat group number 101 and the receiver number for the chat group 103, an e-mail address 112_B@Liiho.com is generated as the sender e-mail address 61. In this embodiment, step S6 is executed by the second program code 22 of the message transmission program 20. Please note that in this embodiment, although the sender e-mail address 61 is generated according to the chat group number 101 and the receiver number for the chat group 103, the scope of the present invention is not limited to the above description. The server 10 can generate the sender e-mail address 61 according to any other equivalent ways.

### Step S7: Storing the Sender Information, the Sender E-Mail Address 61, and the Chat Group Information in the Database 13.

As shown in FIG. 6, after the server 10 generates the chat group information and the sender e-mail address 61, it will store them into the database 13. Accordingly, if the sender 80 would like to send a message to the receiver 81 in the future, the sender e-mail address 61 can be directly retrieved from the database 13.

Step S8: Transmitting the First E-Mail 60 to the Receiver 81.

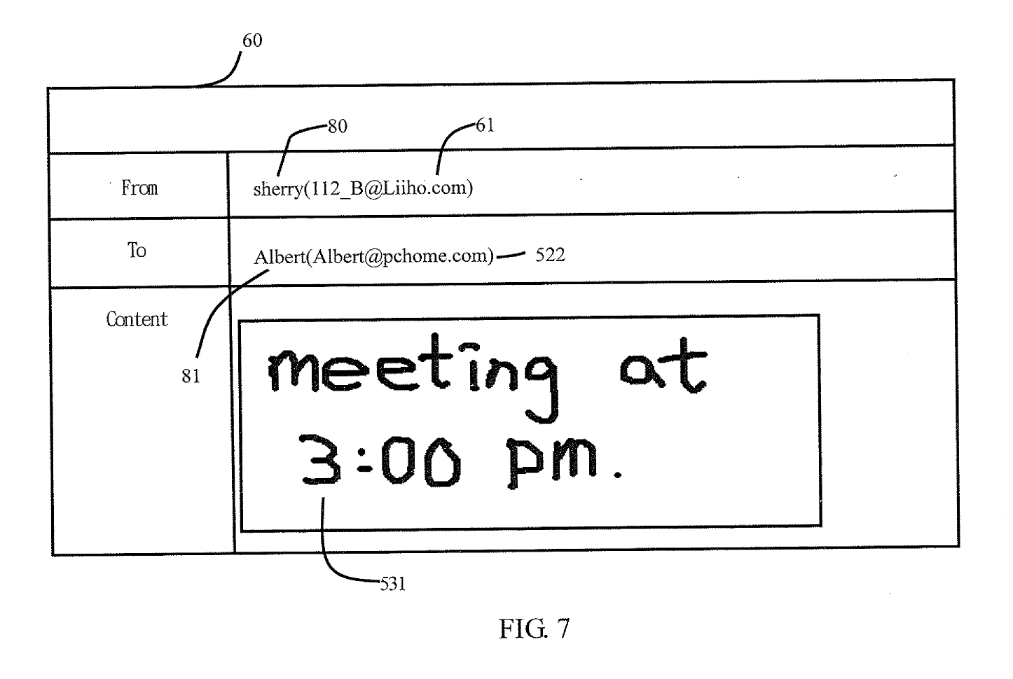

Please refer to FIG. 7. The server 10 utilizes the sender 80 as a sender name, and sends a first e-mail 60 from the sender e-mail address 61 to the receiver e-mail address 522, wherein the content of the first e-mail 60 includes the sender message 531. In this embodiment, the content of the sender message 531 is displayed in the form of an image file, but the scope of the present invention is not limited to the above description. In this embodiment, step S8 is executed by the third program code 23 of the message transmission program 20.

### Step S9: Receiving the First E-Mail 60.

The receiver 81 receives, via the electronic device 30a, the first e-mail 60 transmitted by the server 10.

### Step S10: Receiving the Reply Message 71 of the Receiver 81 and Sending the Second E-Mail 70 to the Server 10.

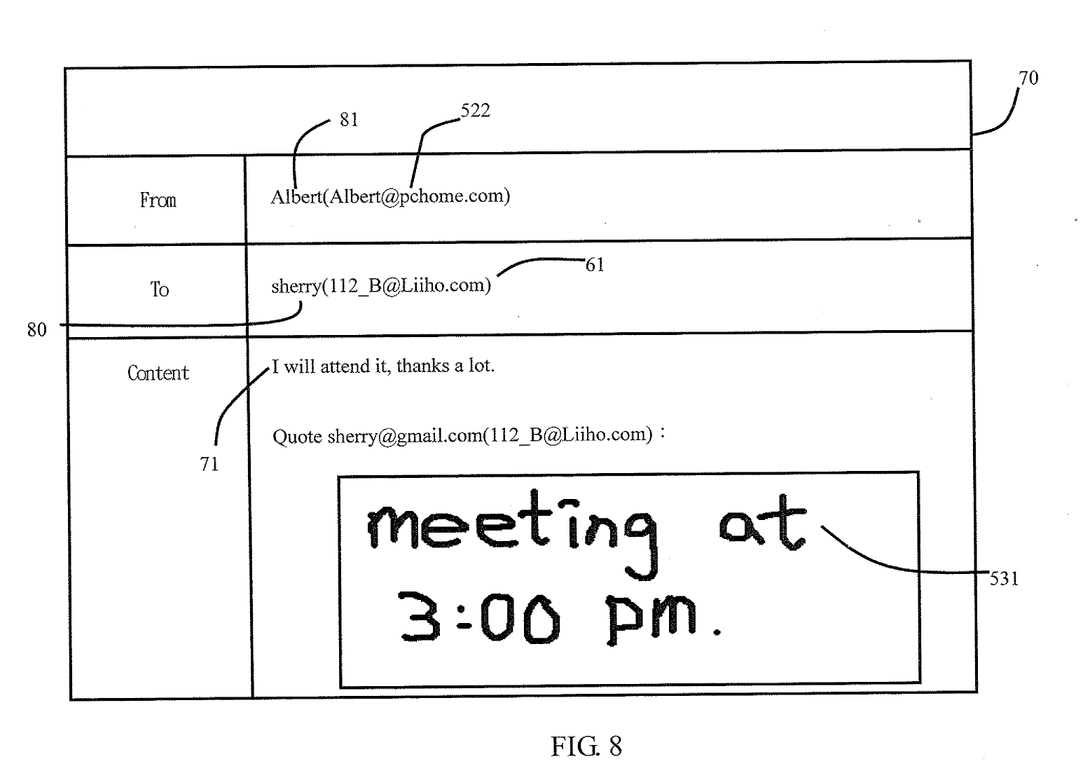

Please refer to FIG. 8, which illustrates a schematic drawing of the second e-mail 70 according to one embodiment of the present invention. After the receiver 81 reads the first e-mail 60, the receiver 81 would like to reply to the sender 80 with the reply message 71. Therefore, the electronic device 30a receives the reply message 71, and transmits the second e-mail 70 with the content including the reply message 71 to the server 10, so as to deliver the reply message 71 from the receiver e-mail address 522 to the sender e-mail address 61. In this embodiment, the reply message 71 is a text message of “I will attend it, thanks a lot”, but please note that the scope of the present invention is not limited to the above description. The reply message 71 can also be a message in the form of HTML or other forms.

### Step S11: Receiving the Second E-Mail 70.

The server 10 receives the second e-mail 70 transmitted from the receiver 81, wherein the content includes the reply message 71. In this embodiment, step S11 is executed by the fourth program code 24 of the message transmission program 20.

### Step S12: Searching the Database 13 According to the Sender E-Mail Address 61 to Confirm the Identity of the Receiver 81.

After the server 10 receives the second e-mail 70, it conducts a search in the database 13 according to the sender e-mail address 61 so as to obtain the receiver e-mail address 522, such that the server 10 can compare the receiver e-mail address 522 with the e-mail address of the sender in the second e-mail 70, thereby confirming the identity of the receiver 81. Please refer to FIG. 6 and FIG. 8; in this embodiment, according to the sender e-mail address 61, 112_B@Liiho.com, the present invention can find the e-mail address corresponding to the number B in the chat group 112, wherein the search result is Albert@pchome.com, which is the receiver e-mail address 522. Then the present invention compares the receiver e-mail address 522 with the e-mail address of the sender in the second e-mail 70, Albert@pchome.com, and obtains the result that the two e-mail addresses are identical. Therefore, the present invention confirms that the second e-mail 70 was indeed sent by the receiver 81. In this embodiment, step S12 is executed by the fifth program code 25 of the message transmission program 20.

### Step S13: Transmitting the Reply Message 71 to the Sender 80.

After the server 10 confirms the identity of the receiver 81, it will transmit the reply message 71 from the receiver 81 to the sender 80. Meanwhile, the reply message 71 will be transmitted to other contact persons in the chat group. In this embodiment, the server 10 will transmit the reply message 71 to the original sender Sherry and the friend Mickey appointed by the original sender. At the same time, in order to make other contact persons aware of the sender of the reply message 71, the server 10 can further transmit the receiver e-mail address 522 to Sherry and Mickey.

In this embodiment, step S13 is executed by the sixth program code 26 of the message transmission program 20.

Step S14: Receiving the Reply Message 71 for being Displayed in the Chat Box 54.

As shown in FIG. 9, after the sender 80 receives the reply message 71 and the receiver e-mail address 522, the sender 80 first recognizes the identity of the receiver 81, and then the reply message 71 is displayed in a receiver field of the chat box 54. Please note that the method of displaying is not limited to the one illustrated in FIG. 9. In the second e-mail 70, if the reply message 71 is displayed in an HTML format, the chat box 54 can provide an embedded browser for the sender 80 to browse the reply message 71 through the browser.

Although the present invention has been explained in relation to its preferred embodiments, it is to be understood that many other possible modifications and variations can be made without departing from the spirit and scope of the invention as hereinafter claimed.

What is claimed is:

1. A method for transmitting and receiving messages, which is used for a server, such that the server can transmit messages between a sender and a receiver via a network, the method comprising the following steps:
receiving sender information, wherein the sender information is transmitted from the sender via the network, and the sender information comprises sender identification information, a sender message, and a receiver e-mail address;
providing a sender e-mail address;
sending a first e-mail from the sender e-mail address to the receiver e-mail address, wherein the first e-mail comprises the sender message;
receiving a second e-mail replied by the receiver, wherein the second e-mail is sent to the sender e-mail address, and the second e-mail includes a reply message; and
transmitting the reply message to the sender.

2. The method as claimed in claim 1, further comprising the following step:
providing chat group information, which comprises a chat group number and a sender number for the chat group.

3. The method as claimed in claim 2, wherein the server provides the sender e-mail address according to the chat group number and the sender number for the chat group.

4. The method as claimed in claim 2, wherein the chat group information further comprises a receiver number for the chat group.

5. The method as claimed in claim 4, further comprising: storing the sender identification information, the receiver e-mail address, the chat group number, the sender number for the chat group, the receiver number for the chat group, and the sender e-mail address into a database.

6. The method as claimed in claim 5, wherein the sender e-mail address is retrieved from the database.

7. A method for transmitting and receiving network messages, which is used in an electronic device, wherein a sender is allowed to transmit a sender message to a receiver via a server, and the receiver is allowed to reply with a reply message to the sender via the server, the method comprising the following steps:
providing an input interface for the sender to input the sender message;
receiving the sender message provided by the sender;
providing a contact list, wherein the contact list comprises at least one receiver name and at least one e-mail address, and each receiver name corresponds to an e-mail address;
receiving an instruction from the sender of selecting a receiver name as the receiver so as to obtain the receiver e-mail address;
displaying the sender message in a chat box;
transmitting a sender information to the server, wherein the sender information comprises the sender message and the receiver e-mail address;
receiving a reply information transmitted from the server, wherein the reply information comprises the reply message; and
displaying the reply message in the chat box.
